(19) United States
(12) Patent Application Publication
(10) Pub. No.: US 2024/0331261 A1
(43) Pub. Date: Oct. 3, 2024

(54) BAKELESS KEYFRAME ANIMATION SOLVER

(71) Applicant: Electronic Arts Inc., Redwood City, CA (US)

(72) Inventor: Sylvain Cote, Montreal (CA)

(21) Appl. No.: 18/622,632

(22) Filed: Mar. 29, 2024

Related U.S. Application Data
(60) Provisional application No. 63/455,709, filed on Mar. 30, 2023.

(51) Int. Cl. G06T 13/80

(52) U.S. Cl. CPC G06T 13/80

(57) ABSTRACT

The systems and methods described herein provide a bakeless keyframe animation solver that enables creation of keyframe poses by manipulation of a skeleton and authors animations through interpolation. A manipulation module enables the manipulation of joints of a skeleton to produce keyframes without the need to bake animations that are driven by a rig. An interpolation module uses the manipulation module to change the kinematic properties (e.g., FK and IK) of one or more joints when interpolating between one or more keyframes to create an animation.

### CROSS REFERENCE TO RELATED APPLICATIONS

Any and all applications for which a foreign or domestic priority claim is identified in the Application Data Sheet as filed with the present application are incorporated by reference under 37 CFR 1.57 and made a part of this specification.

### BACKGROUND

Traditional baking animation techniques require the use of rigs for posing characters to create keyframes. However, rigs introduce complexities to the manipulation of joints since they include kinematic properties defined as either forward kinematics or inverse kinematics. Techniques to switch or alternate between kinematic types of a rig are complex and require technical expertise, which makes it difficult for animators or artists to quickly iterate and produce keyframes without the assistance of an engineer or technical artist. Therefore, there is a need for a bakeless keyframe animation solver (e.g., a rig-less solution) for creating keyframes in the field of animation.

### SUMMARY

In some aspects, the techniques described herein relate to a system including: at least one processor; and at least one memory device, wherein the at least one memory device is communicatively coupled to the at least one processor, the at least one memory device storing computer-executable instructions defining at least an animation solver, wherein execution of the computer-executable instructions, during runtime of the animation solver, causes the at least one processor to: receive a joint selection corresponding to a first joint among a plurality of joints; instantiate a locator object in a first world space position; translate the first world space position of the locator object to a local position corresponding to the first joint; cause the first joint to be manipulated to the local position based in part on joint logic corresponding to the joint selection; and produce one or more keyframes based at least in part on the manipulation.

In some aspects, the techniques described herein relate to a system, wherein causing the first joint to be manipulated to the local position causes one or more joints coupled to the first joint to be manipulated in response to the manipulation of the first joint.

In some aspects, the techniques described herein relate to a system, wherein joints coupled to the first joint are each manipulated based in part on the joint logic corresponding to each coupled joint.

In some aspects, the techniques described herein relate to a system, wherein the joint logic is configurable.

In some aspects, the techniques described herein relate to a system, wherein the joint logic enables the animation solver to manipulate joints without use of rig objects.

In some aspects, the techniques described herein relate to a system, wherein the one or more keyframes produced include a timestamp corresponding to one or more animation sequences.

In some aspects, the techniques described herein relate to a system, wherein the one or more keyframes produced are used to produce a keyframe animation through keyframe interpolation.

In some aspects, the techniques described herein relate to a computer implemented method for an animation solver including: receiving a joint selection corresponding to a first joint among a plurality of joints; instantiating a locator object in a first world space position; translating the first world space position of the locator object to a local position corresponding to the first joint; causing the first joint to be manipulated to the local position based in part on joint logic corresponding to the joint selection; and producing one or more keyframes based at least in part on the manipulation.

In some aspects, the techniques described herein relate to a computer implemented method, causing the first joint to be manipulated to the local position causes one or more joints coupled to the first joint to be manipulated in response to the manipulation of the first joint.

In some aspects, the techniques described herein relate to a computer implemented method, wherein joints coupled to the first joint are each manipulated based in part on the joint logic corresponding to each coupled joint.

In some aspects, the techniques described herein relate to a computer implemented method, wherein the joint logic is configurable.

In some aspects, the techniques described herein relate to a computer implemented method, wherein the joint logic enables the animation solver to manipulate joints without use of rig objects.

In some aspects, the techniques described herein relate to a computer implemented method, wherein the one or more keyframes produced include a timestamp corresponding to one or more animation sequences.

In some aspects, the techniques described herein relate to a computer implemented method, wherein the one or more keyframes produced are used to produce a keyframe animation through keyframe interpolation.

In some aspects, the techniques described herein relate to a computer readable medium storing computer-executable instructions defining at least an animation solver, wherein execution of the computer-executable instructions configure at least one processor to execute a method including: receiving a joint selection corresponding to a first joint among a plurality of joints; instantiating a locator object in a first world space position; translating the first world space position of the locator object to a local position corresponding to the first joint; causing the first joint to be manipulated to the local position based in part on joint logic corresponding to the joint selection; and producing one or more keyframes based at least in part on the manipulation.

In some aspects, the techniques described herein relate to a computer readable medium, wherein causing the first joint to be manipulated to the local position causes one or more joints coupled to the first joint to be manipulated in response to the manipulation of the first joint.

In some aspects, the techniques described herein relate to a computer readable medium, wherein joints coupled to the first joint are each manipulated based in part on the joint logic corresponding to each coupled joint.

In some aspects, the techniques described herein relate to a computer readable medium, wherein the joint logic is configurable.

In some aspects, the techniques described herein relate to a computer readable medium, wherein the joint logic enables the animation solver to manipulate joints without use of rig objects.

In some aspects, the techniques described herein relate to a computer readable medium, wherein the one or more keyframes produced include a timestamp corresponding to one or more animation sequences.

### BRIEF DESCRIPTION OF THE DRAWINGS

This disclosure will be more fully understood from the following detailed description taken in conjunction with the accompanying drawings, in which:

FIG. 1 illustrates a computing environment according to an example embodiment.

FIG. 2A illustrates a software environment, according to an example embodiment.

FIG. 2B illustrates a bakeless keyframe animation solver, according to an example embodiment.

FIG. 3A illustrates a skeleton, according to an example embodiment.

FIG. 3B illustrates a locator object, according to an example embodiment.

FIG. 4 illustrates a process of joint manipulation, according to an example embodiment.

FIG. 5 illustrates a process to produce animation through interpolation of keyframes, according to an example embodiment.

FIG. 6 illustrates an example embodiment of a computing device.

### DETAILED DESCRIPTION

The systems and methods described herein provide a bakeless keyframe animation solver that enables creation of keyframe poses and authors animations through interpolation without the technical complexities and limitations associated with rig baking.

As used herein and known to persons of ordinary skill in the art, baking is the process of building skeletons for character models whose joints are defined and/or constrained in part by rig objects (commonly known or referred to as “rigs”, “control rigs”, and “character rigs”). Baking is typically used to enable the manipulation of one or more joints of a skeleton of character model to configure a pose, such as for producing keyframes or keyframe poses.

Keyframes are poses or representations of a skeleton at a particular frame or point in time during an animation sequence; commonly known as a “timestamp”. Keyframes are used to produce and/or create animations, such as through interpolation.

Rigs are objects that associate one or more joints of a skeleton which configure and/or define kinematic properties—typically as either forward kinematics (FK) or inverse kinematics (IK)—and other movement characteristics and/or movement properties of the joints associated with the rig. As a result, associated joints are “constrained” by the properties corresponding to the rig (e.g., rig properties), which limits the manipulations that can be performed on the associated joints. Traditionally, a baked (e.g., built) rig object cannot have its properties changed or modified. Therefore, when manipulating character models, skeletons, and/or joints that use rigs, animators and artists require a solution that enables transitioning between the kinematic property types (FK and IK), among other things, to efficiently produce poses, keyframes, and/or animations.

Existing methods that address this are often complex and technical, and outside the scope of expertise of an artist or animator. These techniques often rely on destroying, creating, substituting, and/or replacing rig objects to perform manipulations requiring kinematic property type transitions, among other rig property changes. Unfortunately, these techniques relate to the underlying baking process, which often requires technical expertise since the rig objects are being re-baked (e.g., re-built).

The bakeless keyframe animation solver described herein is advantageous in the field of animation as it provides accessible joint manipulation without the technical requirements and complexities of baking rigs. In some embodiments, a bakeless keyframe animation solver uses joint logic (e.g., joint data) corresponding to the joints of a skeleton—among other data, inputs, and values—to drive the manipulation of joints among an editor and/or virtual interactive environment (e.g., an editing scene, commonly known as a “scene”): such as animation editors within a development environment, including those commonly among—or used in conjunction with—a video game engine. As a result, a bakeless keyframe animation solver provides a software driven or data driven approach to joint manipulation, such as for creating poses and/or keyframes, without requiring a rig.

A bakeless keyframe animation solver can include a manipulation module that enables the manipulation of joints (e.g., in a skeleton) directly. The manipulation module can cause a locator object to be manipulated by user input (e.g., change in world space position). The new world space position of the locator object can be converted or translated to a new local position of one or more joints of a skeleton to drive manipulation. During the manipulation of a joint, the manipulation module can define the kinematic properties (e.g., forward kinematics (FK) and inverse kinematics (IK)) of one or more joints dynamically based in part on a configured computer executable instructions or through other user defined properties and/or constraints.

A bakeless keyframe animation solver also includes an interpolation module with computer-executable instructions to create animations through the interpolation of one or more keyframes or poses of a character. The interpolation module can utilize the manipulation module to change the kinematic properties (e.g., FK and IK) of one or more joints of one or more characters when interpolating between one or more poses or keyframes to create an animation. The interpolation module can include computer executable instructions to provide one or more joints of a skeleton, among other objects, with an interpolation object (e.g., interpolator) to drive interpolation. In some embodiments, each joint or object in a scene includes an interpolator. In some embodiments, interpolators are suspended during manipulation.

One skilled in the art would appreciate how a bakeless animation keyframe solver provides an efficient solution for creating keyframe poses and animations. As a result, there is no longer a dependency on character rigs—or the baking thereof—which eliminates the need to utilize complex techniques for managing or rig properties when manipulating the joints of a skeleton to create a keyframe. In turn, a bakeless keyframe animation solver enables artists to quickly produce and iterate on keyframes and animations, thereby providing increased efficiency for producing final animations to incorporate into an animation sequence, such as within a video game.

### Overview

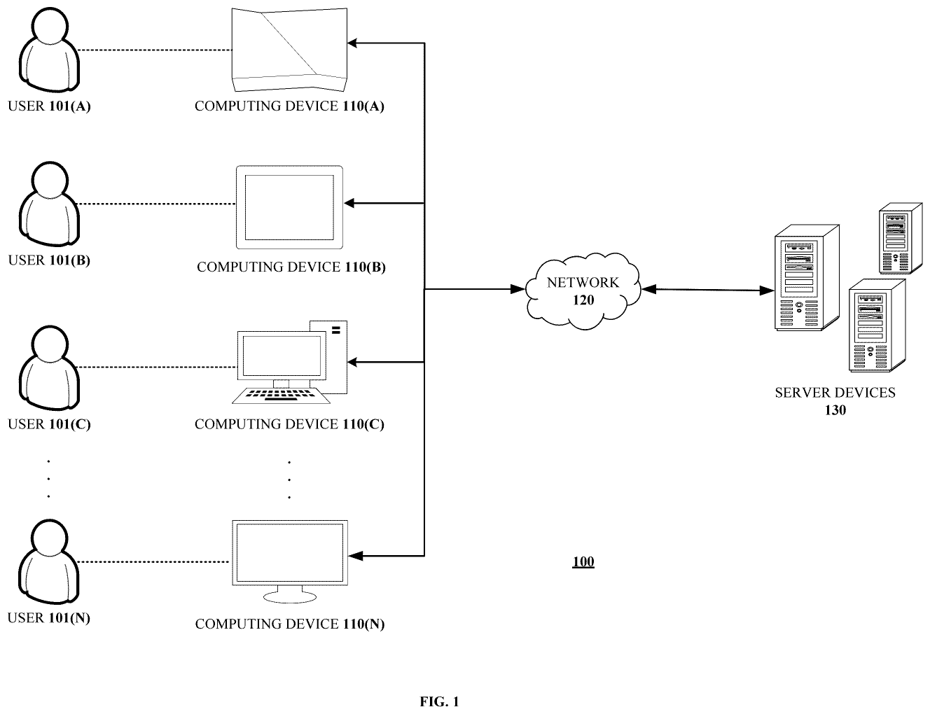

FIG. 1 illustrates an example embodiment of computing environment 100 to design, develop, test, and/or play a video game—or one or more aspects, features, and/or services thereof—among other things. Computing environment 100 includes communicatively coupled hardware devices. In some embodiments, one or more hardware devices among computing environment 100 include computer executable instructions configured with a bakeless keyframe animation solver that enables creation of keyframe poses through direct skeletal joint manipulation, the keyframes of which can be used to author animation through interpolation.

As shown, computing environment 100 including users 105(A), 105(B), 105(C), and 105(N) (collectively referred to herein as “105” or “users 105”) and computing devices 110(A), 110(B), 110(C), and 110(D) (collectively referred to herein as “110 or “computing devices 110”) that are communicatively coupled to server devices 130 over network 250. In some embodiments, “N” of user 105(N) and computing devices 110(N) is an arbitrary real value that denotes an “A through N” number of users 105 and/or computing devices 110 among computing environment 100.

Users 105 can be players, developers, designers and/or automated agents (hereinafter “agent” in short), among other types. In some embodiments, there is a one-to-one correspondence between the users 105 and the computing devices 110. In some embodiments, there is an N-to-one or one-to-N (wherein “N” is an arbitrary real value) correspondence between the users 105 and the computing devices 110. It should be understood that as described in the present disclosure, a “user” on or of a computing device is synonymous with a “player”, “developer”, “designer” or an “agent”. An agent, as known to a person of ordinary skill in the art, can be configured by way of a machine learning model and/or software to automate one or more tasks; such as, for example, playing or testing a video game.

Computing devices 110 are exemplary hardware devices including computer executable instructions configured for designing, developing, maintaining, monitoring, analyzing, testing, updating, streaming, and/or playing a video game—or one or more aspects, features, and/or services thereof—among other things. As illustrated by way of example in the embodiment of FIG. 1, computing device 110(A) is a video game console; computing device 110(B) is a mobile device; computing device 110(C) is a personal computer; and computing device 110(D) is a display device. In some embodiments, two or more of the computing devices 110 are similar to one another—e.g., of a same type.

In some embodiments, user 105 provides input to computing devices 110 by way of one or more input devices and/or input methods corresponding and/or associated to computing devices 110, as known to a person of ordinary skill in the art. In some embodiments, computing devices 110 can provide output to users 105 by way of one or more output devices and/or output methods corresponding and/or associated to computing devices 110, as known to a person of ordinary skill in the art.

Network 250 communicatively couples computing devices 110 and server devices 130, among other hardware devices. In some embodiments, network 250 includes any method of private and/or public connectivity, networking, and/or communication between or among hardware devices known in the arts. As non-limiting examples, network 250 may include direct wired connections, Near Field Communication (NFC), a Local Area Network (LAN), a Virtual Private Network (VPN), an internet connection, or other communication methods of the like.

Server devices 130 are exemplary hardware devices including computer executable instructions configured to provide services (e.g., remote or cloud services) corresponding to designing, developing, maintaining, monitoring, analyzing, testing, updating, streaming, and/or playing of a video game—or one or more aspects and/or features thereof—among other things to computing devices 110 over network 250. The one or more hardware devices of server devices 130 can be communicatively coupled to one or more computing devices 110 over network 250, among other hardware devices and/or other networking methods.

The exemplary hardware devices of computing devices 110 and server devices 130 include at least one or more processors, graphic processors, memory, and storage, in addition to networking capabilities. In some embodiments, computing devices 110 include computer executable instructions configured to perform one or more functions, tasks, or services of and/or for service devices 130. In some embodiments, server devices 130 include computer executable instructions configured to perform one or more functions, tasks, or services of and/or for computing devices 110.

In some embodiments, computing devices 110 and server devices 130 include computer executable instructions configured to provide and/or enable remote access among hardware devices, such as over network 250. For example, computing device 110(A) may remote access computing device 110(C) and/or one or more hardware devices of server devices 130. In some embodiments, computing devices 110 include computer executable instructions configured to request and/or provide data to server devices 130, such as over network 250. In some embodiments, server devices 130 include computer executable instructions configured to request and/or provide data to computing devices 110, such as over network 250.

In some embodiments, there is an association of a user 105 to one or more user accounts of, or corresponding to, computing devices 110 and/or service devices 130. In some embodiments, there is an association of a user 105 to one or more user accounts corresponding to software and/or video games included, stored, and/or executed among computing devices 110 and/or service devices 130. In some embodiments, user accounts in association with a user 105 are validated by computing devices 110 and/or service devices 130 by one or more methods known to a person of ordinary skill in the art. In some embodiments, agents—as users 105—are deployed, controlled, and/or directed by computing devices 110 and/or service devices 130 by one or more methods known to a person of ordinary skill in the art to perform and/or automate one or more tasks among computing devices 110 and/or service devices 130, among other things.

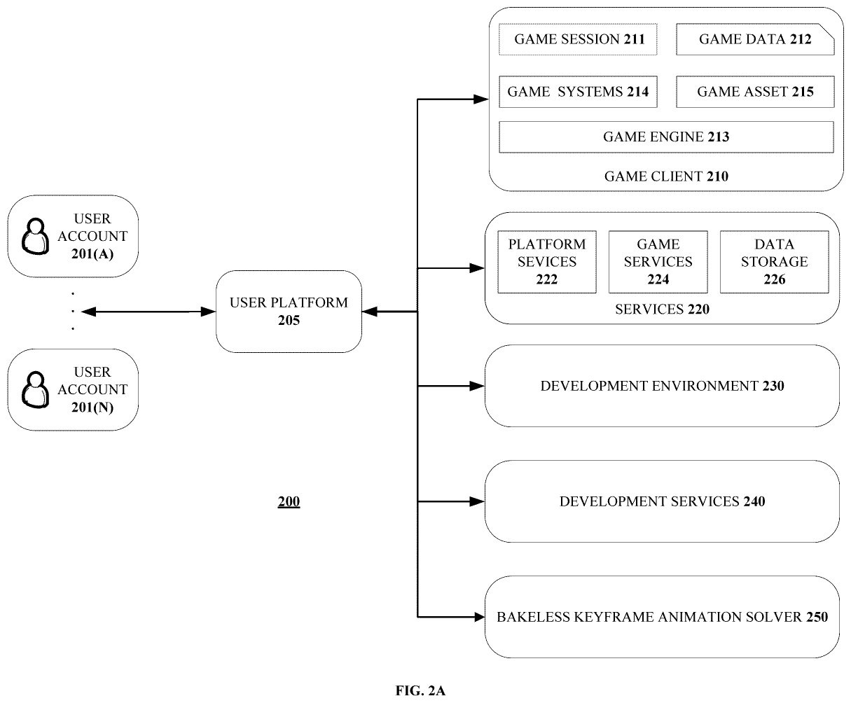

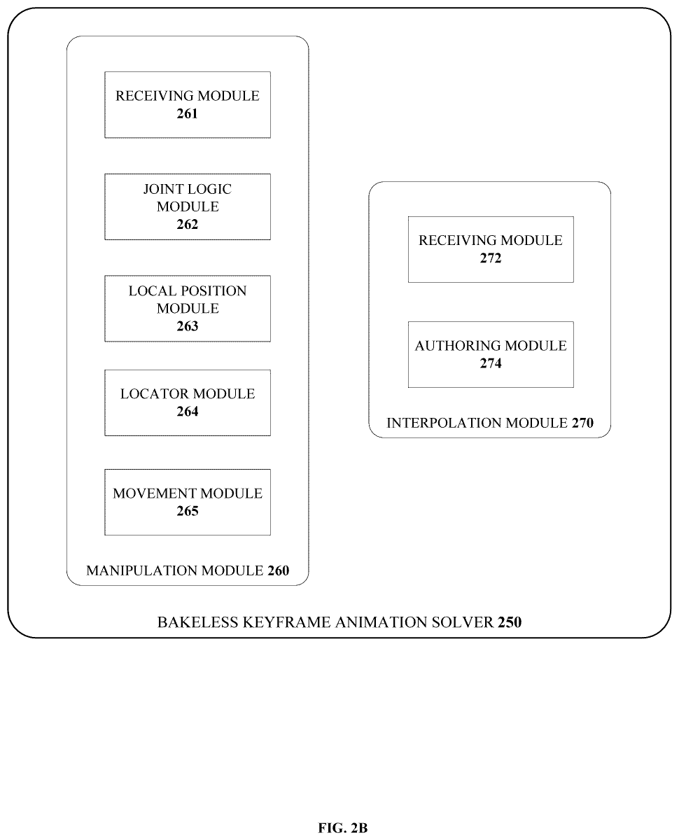

FIG. 2 illustrates an example embodiment of a software environment 200 to design, develop, test, and/or play a video game—or one or more aspects, features, and/or services thereof—among other things. Software environment 200 includes a number of software (e.g., computer executable instructions) distributed over—and/or executable on—one or more communicatively coupled hardware devices, similar to computing device 110 and server device 130 over network 250 of FIG. 1. In some embodiments, the software among software environment 200 is used to author animation through interpolation of keyframe poses created through direct skeletal joint manipulation, such as by way of a keyframe animation solver.

Software environment 200 includes user platform 205, game client 210, service 220, development environment 230, and development service 240. In some embodiments, the software among software environment 200 is configured with computer executable instructions to communicate data.

User platform 205 includes computer executable instructions configured to access and/or manage software and/or services associated with user platform 205, among other things; such as, for example, game clients 210, services 220, development environment 230, and/or development services 240.

In some embodiments, user platform 205 supports and/or requires a “users account” for accessing and/or managing software and/or services associated with user platform 205. As illustrated by way of example in the embodiment of FIG. 2, user account 201(A) through user account 201(N) are accounts of users (similar to users 105 of FIG. 1) that correspond to user platform 205; wherein “N” is arbitrary real value used to denote an “A through N” amount of user accounts (herein collectively referred to as “201”). In some embodiments, each user account 201 may locally execute and/or remotely access or communicate with one or more of the software and/or services among software environment 200 from or on one or more hardware devices.

In some embodiments, user accounts 201 includes data provided by users, such as a username, which identifies a user account 201 (and in turn a user) among software environment 200. In some embodiments, data corresponding to and/or communicated among software environment 200 can be associated to and/or with user platform 205 and one or more user accounts 201. In some embodiments, data corresponding to user platform 205—and one or more user accounts 201—is associated to or with game clients 210, services 220, development environment 230, and/or development service 240, among other things.

Game client 210 is software including, comprising, and/or composing a video game, or portion thereof. Game client 210 includes game client components (213, 214, 215) and game data 212 that can be used to produce and/or maintain game session 211; or multiples thereof.

Game session 211 is an instance of one or more virtual interactive environments of game client 210. In some embodiments, a virtual interactive environment includes one or more virtual levels and/or graphical user interfaces providing an interactive virtual area or virtual space for gameplay and/or socializing. For example, game session 211 can be among a game level or social space, which may include one or more player characters, non-player characters, quests, objectives, and other features, elements, or aspects known in the art. In some embodiments, game session 211 is produced and/or maintained in part by game data 212, game engine 213, game systems 214, and game assets 215, among other things; such as, for example, user platform 205 and/or services 220.

As a non-limiting example, a first instance of a game session may be of a first version of a first virtual interactive environment, while a subsequent instance of a game session may be of a subsequent version of the first virtual interactive environment, such that there are one or more changes or differences among the first virtual interactive environment between the two instances of the game session.

Game session 211 may include a number of player characters and/or non-player characters. Player characters of game session 211 can refer to controllable character models configured to facilitate or perform gameplay actions or commands. In some embodiments, a user or player can control and/or direct one or more player characters in a virtual interactive environment of game session 211. The term “non-player character” corresponds to character models that are not controlled and/or directed by players (commonly known as “NPCs”). An NPC can be configured with computer executable instructions to perform one or more tasks and/or actions among the gameplay of game session 211 (e.g., gameplay actions); such as with and/or without interaction with or from a player character.

The game session 211 may include a number of player objects. Player objects of game session 211 can refer to controllable objects, or models, used to facilitate or enable gameplay or other in-game actions. Player objects may be, for example, vehicles, vessels, aircraft, ships, tiles, cards, dice, pawns, and other in-game items of the like known to those of skill in the art. In some embodiments, a user or player can control or direct one or more player objects in game session 211, including, in some instances, by controlling player characters which in turn causes the objects to be controlled.

For simplicity, player characters and player objects are collectively referred to herein as player characters in some embodiments. It should be understood that, as used herein, “controllable” refers to the characteristic of being able and/or configured to be controlled and/or directed (e.g., moved, modified, etc.) by a player or user through one or more input means, such as a controller or other input device, by a player or user. As known to a person of ordinary skill in the art, player characters include character models configured to receive input.

Game data 212 is data corresponding to one or more aspects of game client 210, such as gameplay. In some embodiments, game data 212 includes data such as state data, simulation data, rendering data, and other data types of the like.

State data is commonly known as data describing a state of a player character, virtual interactive environment, and/or other virtual objects, actors, or entities—in whole or in part—at one or more instances or periods of time during a game session of a video game. For example, state data can include the current location and condition of one or more player characters among a virtual interactive environment at a given time, frame, or duration of time or number of frames.

Simulation data is commonly known as the underlying data corresponding to simulation (i.e., physics and other corresponding mechanics) to drive the simulation of a model or object in a game engine. For example, simulation data can include the joint and structural configuration of a character model and corresponding physical forces or characteristics applied to it at instance or period of time during gameplay, such as a “frame”, to create animations, among other things.

Render Data is commonly known as the underlying data corresponding to rendering (e.g., visual and auditory rendering) aspects of a game session, which are rendered (e.g., for output to an output device) by a game engine. For example, render data can include data corresponding to the rendering of graphical, visual, auditory, and/or haptic output of a video game, among other things.

In some embodiments, gameplay session 211 is based in part on game data 212. During game session 211 (e.g., runtime execution), one or more aspects of gameplay (e.g., rendering, simulation, state, gameplay actions of player characters) uses, produces, generates, and/or modifies game data 212 or portion thereof. Likewise, gameplay events, objectives, triggers, and other aspects, objects, or elements of the like also use, produce, generate, and/or modify game data 212, or a portion thereof. In some embodiments, game data 212 includes data produced or generated over the course of a number of game sessions associated with one or more game clients 210.

Game data 212 may be updated, versioned, and/or stored periodically as a number of files to a memory device associated with game client 210, or remotely on a memory device associated with a game server or game service, such as data storage 226. Additionally, game data 212, or copies and/or portions thereof, can be stored, referenced, categorized, or placed into a number of buffers or storage buffers. A buffer can be configured to capture particular data, or data types, of game data 212 for processing and/or storage. These buffers can be used by game client 210, service 220, user platform 205, development environment 230, and/or development services 240 for performing one or more tasks.

Game client components (e.g., game engine 213, game systems 214, game assets 215) are portions or subparts of game client 210 that provide the underlying frameworks and software that support and facilitate features corresponding to gameplay, such as instancing game sessions that connect one or more user accounts for gameplay among a virtual interactive environment.

Game engine 213 is a software framework configured with computer executable instructions to execute computer executable instructions corresponding to a video game (e.g., game code). In some embodiments, game engine 213 is a distributable computer executable runtime portion of development environment 230. In some embodiments, game engine 213 and development environment 230 are game code agnostic.

In some embodiments, game engine 213 includes, among other things, a renderer, simulator, and stream layer. In some embodiments, game engine 213 uses game data (e.g., state data, render data, simulation data, audio data, and other data types of the like) to generate and/or render one or more outputs (e.g., visual output, audio output, and haptic output) for one or more hardware devices.

As used herein in some embodiments, a renderer is a graphics framework that manages the production of graphics corresponding to lighting, shadows, textures, user interfaces, and other effects or game assets of the like. As used herein in some embodiments, a simulator refers to a framework that manages simulation aspects corresponding to physics and other corresponding mechanics used in part for animations and/or interactions of gameplay objects, entities, characters, lighting, gasses, and other game assets or effects of the like.

As used herein in some embodiments, a stream layer is a software layer that allows a renderer and simulator to execute independently of one another by providing a common execution stream for renderings and simulations to be produced and/or synchronized (i.e., scheduled) at and/or during runtime. For example, a renderer and simulator of game engine 213 may execute at different rates (e.g., ticks, clocks) and have their respective outputs synchronized accordingly by a stream layer.

As used herein in some embodiments, game engine 213 also includes an audio engine or audio renderer that produces and synchronizes audio playback with or among the common execution of a stream layer. In some embodiments, an audio engine of game engine 213 can use game data to produce audio output and/or haptic output from game data. In some embodiments, an audio engine of game engine 213 can transcribe audio data or text data to produce audio haptic output.

Game systems 214 includes software configured with computer executable instructions that provide, facilitate, and manage gameplay features and gameplay aspects of game client 210. In some embodiments, game systems 214 includes the underlying framework and logic corresponding to gameplay of game client 210. For simplicity, game systems 214 are the “game code” that compose a video game of game client 210. As such, game systems 214 are used in part to produce, generate, and maintain gameplay among an instance of a virtual interactive environment, such as the gameplay among game session 211.

As used herein in some embodiments, game engine 213 and/or game systems 214 can also use and/or include Software Development Kits (SDKs), Application Program Interfaces (APIs), Dynamically Linked Libraries (DLLs), and other software libraries, components, modules, shims, or plugins that provide and/or enable a variety of functionality to game client 210; such as—but not limited to—graphics, audio, font, or communication support, establishing and maintaining service connections, performing authorizations, and providing anti-cheat and anti-fraud monitoring and detection, among other things.

Game assets 215 are digital assets that correspond to game client 210. In some embodiments, the game assets 215 can include virtual objects, character models, actors, entities, geometric meshes, textures, terrain maps, animation files, audio files, digital media files, font libraries, visual effects, and other digital assets commonly used in video games of the like. As such, game assets 215 are the data files used in part to produce the runtime of game client 210, such as the virtual interactive environments and menus. In some embodiments, game engine 213 and/or game systems 214 reference game assets 215 to produce game session 211.

In some embodiments, game client 210 can be played and/or executed on one or more hardware devices, such as computing devices 110 and server devices 130 of FIG. 1. In some embodiments, there are a number of game clients 210 that may include variations among one another: such as including different software instructions, components, graphical configurations, and/or data for supporting runtime execution among different hardware devices.

For example, multiple game clients 210 can be of the same video game wherein one game client 210 includes variations for support on a video game console (such as computing device 110(A) in FIG. 1), while another game client 210 includes variations for support on a mobile device (such as computing device 110(B) in FIG. 1). However, since the game clients are of the same video game, both game clients can connect to the same instance of a game session (such as game session 211) to enable user accounts 201 of user platform 205 to interact with one another by being communicatively coupled; such as by hardware devices running and/or accessing a game client 210 in communication with services 220.

Service 220 are software services including computer executable instructions configured to provide a number of services to user platform 205 and/or game client 210. As illustrated by way of example in FIG. 2, services 220 includes, but is not limited to, platform services 222, game services 224, and data storage 226. In some embodiments, services 222 includes computer executable instructions configured and/or provided by development environment 230 and/or development services 240.

Platform services 222 includes computer executable instructions configured to provide anti-fraud detection, software management, user account validation, issue reporting, and other services corresponding to user platform 205 of the like.

Game services 224 includes computer executable instructions configured to provide matchmaking services, game state management, anti-fraud detection, economy management, player account validation, and other services corresponding to gameplay of the like to game clients 210.

In some embodiments, platform services 222 and/or game services 224 establish and maintain connections that, at least in part, facilitate gameplay in a game session of game client 210, such that game session 211 of game client 210 connects one or more users accounts 201 of user platform 205 for multiplayer gameplay and/or multi-user interaction among an instance of a virtual interactive environment.

Data storage 226 provides data storage management services to the software among software environment 200. In some embodiments, data communicated by and/or corresponding to elements 205, 201, 210, 220, 230, 240 and 250 may be stored, versioned, and/or managed—as one or more files—to and/or by data storage 226 or one or more hardware devices corresponding to software environment 200.

In some embodiments, Game clients 210 and user platform 205 can communicate with service 220 over a network, such as network 250 illustrated in FIG. 1. In some embodiments, service 220 is provided by server devices 130 of FIG. 1. In some embodiments, game client 210 and/or user platform 205 can require a user account 201 to access one or more features of game client 210; such as social gaming features including multiplayer game sessions or player to player communications. Respectively, data, such as game data 212 corresponding to one or more game sessions of game client 210 can be associated to user accounts 201 in some embodiments.

Development Environment 230 is software enabling the development or maintenance of one or more aspects, features, tools, and/or services corresponding to one or more of the software among software environment 200. In some embodiments, development environment 230 is a collection of tools, frameworks, services, and other computer executable instructions and applications of the like, such as, for example, a video game development engine. In some embodiments, development environment 230 can utilize external software—such as components, modules, libraries, plugins, and other systems of the like—to extend or expand functionality and/or capabilities.

Development Services 240 are software services including computer executable instructions configured to provide services corresponding to user platform 205, game client 210, services 220 and/or development environment 230. In some embodiments, development services 240 provide services similar to functionality and capabilities of development environment 230, thereby allowing and/or enabling development for software corresponding to, and/or aspects of, software environment 200. In some embodiments, development services 240 provide services to mock and/or simulate one or more components, services, or aspects of user platform 205, game client 210, and/or services 220, thereby allowing and/or enabling testing and/or validation, among other things, for one or more aspects corresponding to software environment 200.

Bakeless keyframe animation solver 250 is software configured to author animation through interpolation of keyframe poses created through skeletal joint manipulation. In some embodiments, bakeless keyframe animation solver 250 is integrated among and/or a component or module of development environments 230 and/or development services 240. In some embodiments, bakeless keyframe animation solver 250 is external software used by development environment 230 and/or development services 240.

In some embodiments, software among or corresponding to software environment 200—and the corresponding systems and methods thereof—utilize machine learning. Machine learning is a subfield of artificial intelligence, which, to persons of ordinary skill of the art, corresponds to underlying algorithms and/or frameworks (commonly known as “neural networks” or “machine learning models”) that are configured and/or trained to perform and/or automate one or more tasks or computing processes. For simplicity, the terms “neural networks” and “machine learning models” can be used interchangeably and can be referred to as either “networks” or “models” in short.

In some embodiments, software among or corresponding to software environment 200—and the corresponding systems and methods thereof—utilize deep learning. Deep learning is a subfield of artificial intelligence and machine learning, which, to persons of ordinary skill of the art, corresponds to multilayered implementations of machine learning (commonly known as “deep neural networks”). For simplicity, the terms “machine learning” and “deep learning” can be used interchangeably.

As known to a person of ordinary skill in the art, machine learning is commonly used for performing and/or automating one or more tasks such as identification, classification, determination, adaptation, grouping, and generation, among other things. Common types (e.g., classes or techniques) of machine learning include supervised, unsupervised, regression, classification, reinforcement, and clustering, among others.

Among these machine learning types are a number of model implementations, such as linear regression, logistic regression, evolution strategies (ES), convolutional neural networks (CNN), deconvolutional neural networks (DNN), generative adversarial networks (GAN), recurrent neural networks (RNN), and random forest, among others. As known to a person of ordinary skill in the art, one or more machine learning models can be configured and trained for performing one or more tasks at runtime of the model.

As known to a person of ordinary skill in the art, the output of a machine learning model is based at least in part on its configuration and training data. The data that models are trained on (e.g., training data) can include one or more data types. In some embodiments, the training data of a model can be changed, updated, and/or supplemented throughout training and/or inference (e.g., runtime) of the model. In some embodiments, training data corresponds to one or more data types corresponding to software among software environment 200.

A “machine learning module” is a software module and/or hardware module including computer-executable instructions to configure, train, and/or deploy (e.g., execute) one or more machine learning models. In some embodiments, software corresponding to software environment 200 includes one or more machine learning modules.

FIG. 2B illustrates an example embodiment of a system overview for a bakeless keyframe animation solver 250 (hereinafter “BKAS” for short). BKAS 250 includes manipulation module 260 and interpolation modules 270, among other things. Manipulation module 260 provides the underlying logic and functionality for, among other things, manipulating joints of a skeleton, such as to or for producing keyframes. Interpolation module 270 provides the underlying logic and functionality to, among other things, produce animations through interpolation of keyframes and/or other poses.

As described herein, BKAS 250 can be used during development corresponding to character modeling and/or animation for solving and/or applying movement characteristics to joints of a skeleton when or for manipulating a character model into one or more poses for creating and/or capturing one or more keyframes.

It should be understood that character modeling as used herein refers to the creation and/or configuration of a player character or character model, including the joints that compose a skeleton of the character. Skeletons—and their joints—are virtual objects that can be associated with or to one or more character models. Character skeletons (e.g., skeletons associated with a character model) are used at least in part to produce animations by, for example, the posing of a character model to be captured as a keyframe or keyframe pose. A keyframe represents a skeleton's pose at a given point in time, such as a point in time among an animation sequence. As such, a keyframe includes information about the skeleton and joints of a character model—namely properties such as their world space position, size, rotation, scale, and others known to those of skill in the art. For simplicity, a keyframe is synonymous with “keyframe pose”.

Traditionally, properties such as kinematic properties and movement limitations or constraints (e.g., defining the degree, area, and method of permissible or restricted manipulation) are applied or plotted to joints and skeletons of a character model by or through a rig. The character model and/or corresponding skeleton become dependent on a rig during a baking process that introduces and or leads to complexities downstream for or during joint manipulation when posing a character model to create a keyframe.

Here, in contrast, BKAS 250 allows physical properties (. e.g., kinematic properties) to be applied or plotted to joints without the use of a rig, thereby enabling the manipulation of joints of skeleton (e.g., directly) and foregoing the need to use and bake control rigs to pose a skeleton and/or character model to create or produce keyframes (e.g., providing a bakeless solution). As a result, BKAS 250 also allows kinematic properties to be modified without the requirement or need to rebuild or rebake control rigs.

Manipulation module 260 of BKAS 250 includes receiving module 261, identification module 262, local position module 263, locator module 264, and movement module 265, among other things. In some embodiments, manipulation module 260 enables the manipulation of joints of a skeleton to produce one or more poses and/or keyframes.

In some embodiments, receiving module 261 includes computer executable instructions configured to receive, access, and/or request a joint selection of a joint corresponding to a character skeleton and/or character model. In some embodiments, a joint selection received is based in part on user input: such as from a user similar to user 105 of FIG. 1 and/or input associated with a user account 205 of FIG. 2A. In some embodiments, receiving module 261 receives one or more joint selections. A received joint selection enables BKAS 250 to manipulate a corresponding joint, such as by way of the proceeding modules of manipulation module 260.

In some embodiments, joint logic module 262 includes computer executable instructions configured to define, identify, modify and/or otherwise configure joint logic corresponding to and/or associated with a joint, such as the joint corresponding to the joint selection received by receiving module 216. As a result, the joint logic provided and/or made accessible by joint logic module 262 enables BKAS 250 to have a data-driven or software based approach and/or implementation to manipulate joints: thereby, providing joint manipulation without the use of rig objects.

In some embodiments, joint logic is data of properties, constraints, and/or characteristics corresponding to at least: (i) the selected joint, (ii) joints coupled to the selected joint, (iii) the couplings between the selected joints and other joints, (iv) the anatomical skeletal structure corresponding to the joint selected (e.g., bided, quadruped), and/or (v) the character model corresponding to the skeleton, among other things. For example, joint logic can include data such as size, scale, rotation, location, local position, world space position, velocity, speed, acceleration, and kinematic properties, among other things. For simplicity, the terms “joint logic” and “joint data” are used synonymously.

In some embodiments, joint logic module 262 is configured to designate forward kinematics (FK) as default kinematic property to apply at manipulation, such as by manipulation module 265. In some embodiments, the manipulation module 260 switches and/or alternates between FK and IK: through automation and/or user input. For example, kinematic properties can be applied automatically and/or programmatically based in part on the manipulation of joints, input directing the manipulation of joints, and/or other deterministic logic.

In some embodiments, a change in kinematic property can be applied manually. For example, the joint BKAS 250 can prompt and/or enable a user to alternate, switch, or change the kinematic property, such as when receiving input that directs a joint manipulation.

In some embodiments, local position module 263 includes computer executable instructions configured to translate a world space position to a local position, such as of a received joint selection. A local position, as known to a person of ordinary skill in the art, is a position relative to a virtual object, such as a skeletal joint. In some embodiments, a world space position can be based in part on user input. In some embodiments, a world space position can be based in part on the location of a virtual object.

In some embodiments, locator module 264 includes computer executable instructions configured to instantiate and manipulate a locator object. In some embodiments, a locator object is instantiated at a world space location among a virtual interactive environment corresponding to user input. In some embodiments, the locator object can be manipulated to other world space positions among a virtual interactive environment through user input. In some embodiments, a locator object is used in part to translate a world space position to a local position of a skeletal joint, such as the joint corresponding to the joint selection received by receiving module 261.

In some embodiments, movement module 265 includes computer executable instructions configured to cause a joint to be moved and/or manipulated among a virtual interactive environment from one location to another location. In some embodiments, movement module 265 manipulates a joint based at least in part on the joint logic from joint logic module 262. In some embodiments, movement module 265 also manipulates a joint based at least in part on a locator object instantiated by locator module 264 and local position data relative to the locator object and the joint, as provided by local position module 263. In some embodiments, movement module 265 causes one or more joints coupled to the selected joint to be moved and/or manipulated, such as, for example, in response to the movement of the selected joint.

In some embodiments, movement module 265 and/or manipulation module 260 enables a define a timestamp for a keyframe or pose. As known to a person of ordinary skill in the art, a timestamp marks or indicates a moment in time or frame among an animation sequence to which a keyframe and/or pose corresponds to. For example, a timestamp can indicate a start, end, middle, and/or specific time or specific frame among an animation sequence that a keyframe or pose corresponds to. In some embodiments, a timestamp can be stored and/or captured as data. In some embodiments, a keyframe includes a timestamp.

In some embodiments, one or more poses created in part by manipulations of movement module 265 can be saved and/or captured as keyframes among one or more data buffers or datastores, either automatically or manually. In some embodiments, data corresponding to joint logic is saved or captured among one or more data buffers or datastores, either automatically or manually. In some embodiments, data corresponding to joint logic is associated with or to a keyframe, character model, character skeleton, and/or joint, such as in the form of metadata.

Interpolation module 270 of BKAS 250 includes receiving module 271, identification module 272, authoring module 273, and modification module 274, among other things. In some embodiments, interpolation module 270 operates in conjunction with manipulation module 260 to produce animations.

In some embodiments, interpolation module 270 accesses, requests, and/or receives data produced and/or processed manipulation module 260 to produce animations from keyframes and/or poses. In some embodiments, interpolation module 270 uses one or more modules from manipulation module 260. In some embodiments, interpolation module 270 includes one or more modules similar to the modules of manipulation 260.

In some embodiments, receiving module 272 includes computer executable instructions configured to receive, request, and/or access one or more keyframes and/or poses of—or corresponding to—a character model and/or character skeleton.

In some embodiments, authoring module 274 includes computer executable instructions configured to create an animation through the interpolation, such as between two or more keyframes and/or two or more poses, and/or combinations thereof. Authoring module 275 is configured to use and/or support traditional interpolation methods as known to one skilled in the art, such as, but not limited to, linear interpolations methods, among other things Authoring module 275 is also configured to support unique and/or configurable interpolation methods, as defined or created by a user, such as, for example, unique animation curves or functions. In some embodiments, authoring module 275 provides an interface for modifying and/or creating unique interpolation methods.

In some embodiments, authoring module 275 provides an interface for producing animations, including an animation timeline, among other things. In some embodiments, authoring module 275 can automatically place keyframes among an animation timeline based in part on data; such as a timestamp of a keyframe.

In some embodiments, authoring module 275 interpolates an animation based at least in part on the delta of one or more data types corresponding to two or more keyframes and/or poses. In some embodiments, interpolation module 275 interpolates an animation based in part on the joint logic of one or more joints. In some embodiments, authoring module 275 uses movement module 265 to manipulate and/or modify a keyframe and/or pose.

In some embodiments, BKAS 250 of FIG. 2A and FIG. 2B are the same or similar. In some embodiments, BKAS 250 is configured as an extension, library, application programming interface (API) and/or component of a development environment, such as development environment 230 of FIG. 2A. In some embodiments, BKAS 250 is configured as separate or standalone software communicating and operating in conjunction with a development environment, such as development environment 230 of FIG. 2A.

In some embodiments, keyframes, animations, and other data of the like from or corresponding to BKAS 250 may be saved among a datastore of a hardware device; such as among computing device 110 or server device 130 of FIG. 1, or among data storage 226 of FIG. 2A. In some embodiments, keyframes, animations, and other data of the like from or corresponding to BKAS 250 is included among game data 212 or game assets 215 of game client 210 of FIG. 2A. In some embodiments, keyframes, animations, and other data of the like processed and/or produced by BKAS 250 is available between or among the modules of BKAS 250, and other software among a software environment, such the software among software environment 200 of FIG. 2A.

### Skeleton

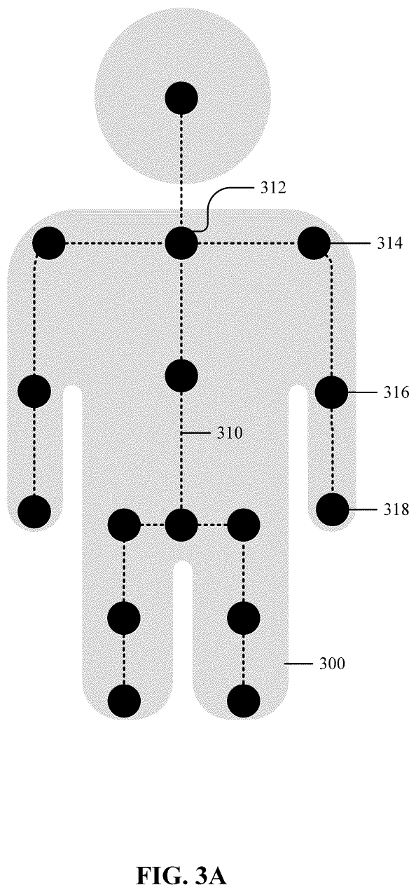

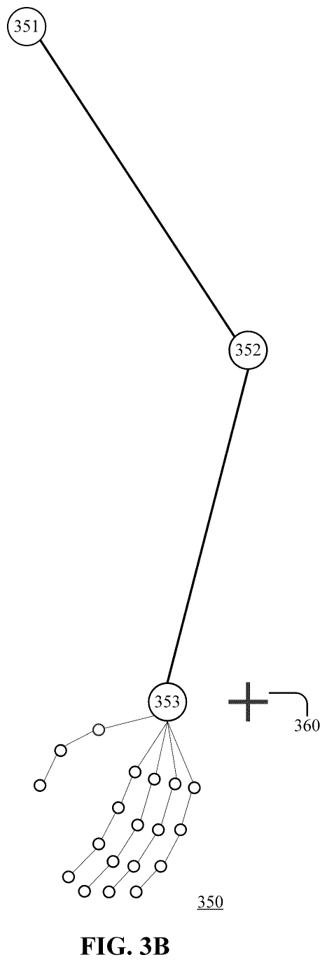

FIG. 3A illustrates an example embodiment of a skeleton (310) associated with a character model (300). In some embodiments, skeleton 310 can be manipulated by a BKAS (similar to BKAS 250 of FIG. 2B) to create keyframes that are used in part to produce animations.

Skeleton 310 is a collection and/or group of one or more joints that can be associated with one or more character models, such as character model 300. In some embodiments, character model 300 is similar to the player characters, as described f FIG. 2A.

In some embodiments, the anatomical structure of skeleton 310 is composed, determined, defined, and/or identifiable based at least in part on a number of joint couplings (e.g., the connectivity, relation, and/or dependencies of joints). For example, the coupling of shoulder joint 314, elbow joint 316, and wrist joint 318 form an “arm” of skeleton 310. The coupling of spine joint 312 to shoulder joint 314 form a portion of the “shoulder”. Therefore, in some embodiments, the joints of the arm (314, 316, and 318) and shoulder (312 and 314) can be considered separate couplings and/or sub-couplings.

In some embodiments, skeleton 310 includes joint logic. In some embodiments, joint logic of skeleton 310 includes data corresponding to joint couplings and/or anatomical structure. In some embodiments, skeleton 310 and its joints are virtual objects. In some embodiments, skeleton 310 includes virtual objects that represent or correspond to the coupling or connectivity of joints (e.g., bone objects between joints).

In some embodiments, a BKAS is configured to cause and/or enable one or more coupled joints of skeleton 310 to be manipulated in response to or in relation to the manipulation of another joint among a coupling. For example, joints 316 and 318 can be manipulated in response to a manipulation of joint 314 and/or 312, based in part on joint logic. In some embodiments, skeleton 310 provides joint logic to a BKAS. In some embodiments, a BKAS is configured to define, identify, configure, and/or modify one or more couplings of joints for skeleton 310 and/or character model 300 based in part on the joint logic known or among the BKAS.

### Locator Object

FIG. 3B illustrates an example embodiment of a locator object used to manipulate joints of a skeleton.

Skeleton arm 350 includes a number of joints (shoulder joint 351, elbow joint 352, and wrist joint 353) that create the main skeletal structure of an arm. In some embodiments, joints 351, 352, and 353 are a coupling. In some embodiments, joints among a coupling can have properties or characteristics based in part on another joint among a corresponding coupling. For example, a local position of a joint can be based in part on at least one other joint among the coupling. In some embodiments, a joint can have—or be described with—a world space position as well as one or more local positions relative to other objects (e.g., other joints or coupled joints).

As an example, wrist joint 353 is coupled to a number of joints that compose a hand for skeleton arm 350. In turn, the local positions of one or more of the hand joints coupled to wrist joint 353 can be based in part on other joints among a respective coupling or other couplings to wrist joint 353, as well as wrist joint 353, elbow joint 352 and shoulder joints 351.

In some embodiments, local positions—and other local properties and characteristics—can be based in part on objects that are not among a coupling. For example, local positions of a joint of a skeleton can be based in part on an object external to a skeleton such as locator object 360, or one or more joints of another skeleton, among other objects.

In some embodiments, a locator object 360 provides data to a BKAS (similar to BKAS 250 of FIG. 2B). In some embodiments, a manipulation module can translate or convert data corresponding to the world space position of a locator object into a local position relative to one or more joints, to perform joint manipulation.

Locator object 360 can be instantiated by a BKAS, temporarily or persistently, at or near a world space location corresponding to user input. For simplicity, locator object 360 is illustrated as a cross in FIG. 3, but one skilled in the art would appreciate the myriad ways a locator object can be configured to be illustrated or rendered.

### Joint Manipulation

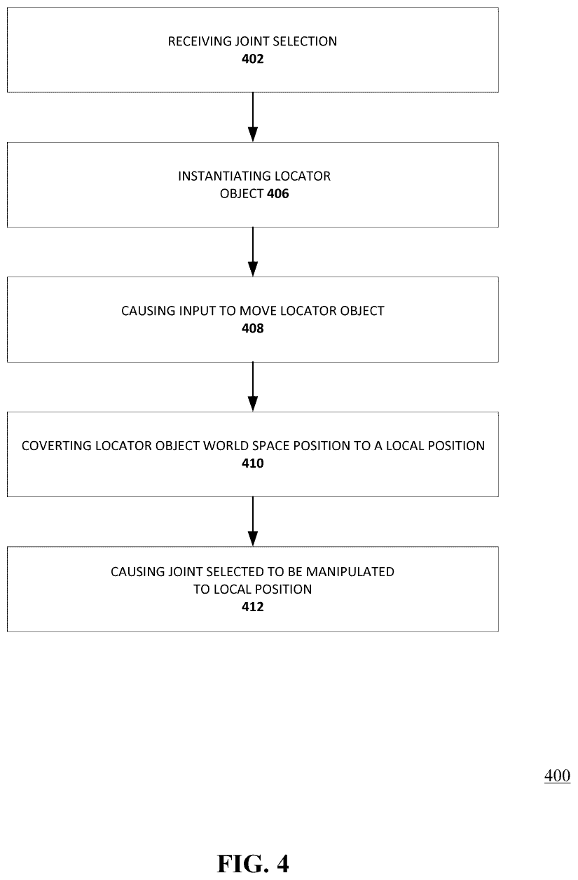

FIG. 4 illustrates an example embodiment of a process to manipulate joints, such as to produce keyframes. Process 400 corresponds to the data driven approach of a BKAS using joint logic to configure, direct, and/or manipulate one or more joints to produce one or more keyframes (e.g., target poses). In some embodiments, process 400 corresponds to a BKAS similar to BKAS 250 of FIG. 2B.

At step 402, a receiving module of a BKAS receives a joint selection. In some embodiments, the receiving module is similar to receiving module 261 of FIG. 2B. In some embodiments, the received joint selection is based in part on user input. In some embodiments, the selection of a joint for step 402 may be performed by selecting an identifier or label among a user interface and/or by selecting a region, portion, or texture of a character model which has been configured to correspond to a joint.

For example, a receiving module can be configured to determine a joint selection by way of user input at or near a portion of a character model (e.g., the selection of texture or region of the character model), wherein the portion is associated to a joint of a corresponding character skeleton.

At step 406 a locator module of a BKAS instantiates a locator object. In some embodiments, the locator module is similar to locator module 264 of FIG. 2B. In some embodiments, a locator object is instantiated at or near user input (e.g., among a virtual interactive environment of a development environment, such as 230 of FIG. 2A). In some embodiments, the locator object is a temporary and/or semi-persistent object that is used to obtain or reference a location among a virtual interactive environment, such as a world space position.

At step 408 a locator module of a BKAS causes the locator object to move in response to user input. In some embodiments, a user—similar to users 105 of FIG. 1—can provide user input to a BKAS and/or development environment that causes the instantiated locator object to move to a world space position among a virtual interactive environment that is different from the current world space position of the locator object. As such, a locator object can be moved and/or manipulated to another world space position associated with user input.

In some embodiments, step 408 can be skipped among process 400 if a locator object is instantiated at a location or position (e.g., world space position) that a user would like to manipulate the selected joint to or towards, thereby not requiring the user to provide additional user input to move the locator object.

At step 410, a local position module of a BKAS converts the world space position of the locator object to a local position corresponding to—or relative to—the selected joint. In some embodiments, the local position module is similar to local position module 263 of FIG. 2B. As known to a person of ordinary skill in the art, a local position is a position relative to another object(s). In some embodiments, a local position includes coordinates that represent a location or position relative to another object, irrespective of where the objects are located in world space (e.g., world space positions).

At step 412 a manipulation module of a BKAS causes the joint selected to be manipulated towards and/or to the local position, based in part on joint logic. Additionally, joints coupled to the joint selected can also be manipulated in response to the manipulation of the selected joint at step 412 as well. The manipulation of coupled joints is also based in part on joint logic corresponding to the coupled joints, respectively.

In some embodiments the manipulation of coupled joints is also based at least in part on the local position determined and/or the position(s) of the selected joint during and/or after manipulation. In some embodiments, joints coupled to the selected joint can be configured not to be manipulated in response to the manipulation of the selected joint.

In some embodiments, the manipulation module is similar to manipulation module 265 of FIG. 2B. As aforementioned, a manipulation module includes joint logic that defines a number of properties, constraints, and/or characteristics of joints. Joint logic can be used during a manipulation process to characterize or constrain the manipulation of joints, such as by limiting a joint manipulation to a particular kinematic property type. Therefore, a manipulation module provides a data drive manipulation of the selected joint and/or joints coupled to the selected joint based in part on joint logic. The manipulation module is configured to determine which joint logic corresponds to the selected joint.

In some embodiments, the joint logic of the selected joint and/or coupled joint(s) (e.g., joints coupled to the selected joint) is configurable, such that one or more characteristics, aspects, or properties can be tuned or configured by animator or artist. For example, the manipulation module can enable the switching between kinematic property types. Additionally, if the manipulation module is unable to correspond or associate any known joint logic to the selected joint, the manipulation module and/or BKAS and request joint logic be configured and/or provided, prior performing the manipulation of the joint.

The steps of process 400 can be repeated a number of times for a number of joints of one or more character models and/or character skeletons to pose the character models and/or character skeletons into a desired pose (e.g., target pose) to produce one or more keyframes. The steps and process of FIG. 4 can be associated to one or more hardware and/or software modules configured with computer-executable instructions. A person of ordinary skill in the art would recognize and appreciate how the proceeding process may be configured in a number of ways, such that one or more of steps are performed before, after, or simultaneously among other steps, and/or otherwise omitted or substituted in whole or in part.

### Keyframe Interpolation

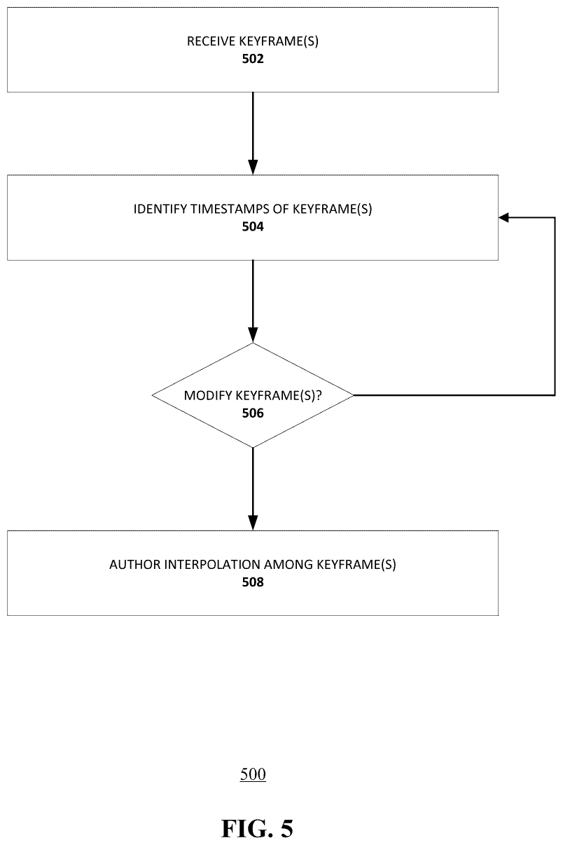

FIG. 5 illustrates an example embodiment of a process to produce animation through interpolation of keyframes produced by a BKAS. In some embodiments, process 500 corresponds to interpolation module 270 of FIG. 2B, and the computer-executable instructions thereof.

At step 502, a receiving module of a BKAS receives and/or accesses one or more keyframes. In some embodiments, the receiving module is similar to receiving module 272 of FIG. 2B.

At step 504, an authoring module of a BKAS identifies one or more timestamps associated with the one or more keyframe poses received. In some embodiments, the authoring module is similar to authoring module 274 of FIG. 2B.

A timestamp is a marker, flag, or other data label type of the like that indicates when a keyframe pose is keyed into an animation sequence, such as a particular time or frame. In some embodiments, the keyframe includes data corresponding to an association to an animation sequence.

For simplicity, an “animation sequence” refers to the association and/or grouping of one or more keyframes that are used in part to produce a resulting animation. For example, the keyframes of an animation sequence can be the start, middle, and end pose of a desired animation, whereas the animation is full simulated movement produced from the start to the end of the animation sequence based at least in part on the keyframes (e.g., keyframe interpolation).

An authoring module uses timestamps to insert keyframes among an animation timeline corresponding to the animation sequence. The animation timeline can be represented with a number of user interface elements, as known in the art, among a development environment.

At step 506, an authoring module and/or BKAS can use a manipulation module to modify and/or change one or more keyframes received. In some embodiments, the manipulation module is similar to the manipulation module 260 of FIG. 2B.

At step 508, an authoring module can author animation through interpolation of keyframes received, based in part on joint logic of a manipulation module. An animation produced from keyframe interpolation is commonly referred to as a “keyframe animation”.

As a result of using joint logic to manipulate joints of the skeleton to create poses for keyframes, process 400 and 500 can be used to quickly and efficiently produce keyframe animations without the complexity associated with rigs that traditionally drive the manipulation of joints of a skeleton.

### Computing Device

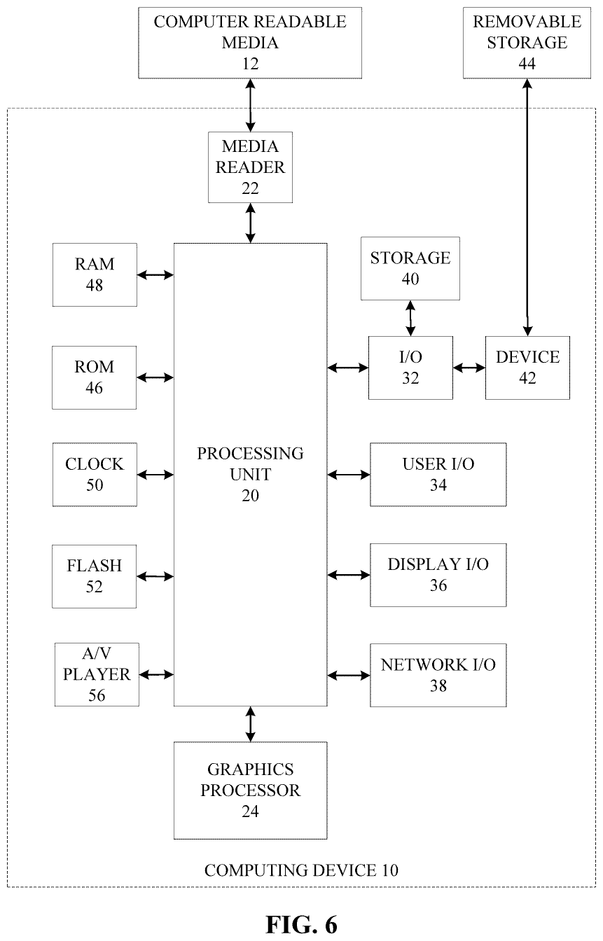

FIG. 6 illustrates an example embodiment of the resources within a computing device 10. In some embodiments, some or all of the aforementioned hardware devices—such as computing devices 110 and server devices 130 of FIG. 1—are similar to computing device 10, as known to those of skill in the art.

Other variations of the computing device 10 may be substituted for the examples explicitly presented herein, such as removing or adding components to the computing device 10. The computing device 10 may include a video game console, a smart phone, a tablet, a personal computer, a laptop, a smart television, a server, and the like.

As shown, the computing device 10 includes a processing unit 20 that interacts with other components of the computing device 10 and external components. A media reader 22 is included that communicates with computer readable media 12. The media reader 22 may be an optical disc reader capable of reading optical discs, such as DVDs or BDs, or any other type of reader that can receive and read data from computer readable media 12. One or more of the computing devices may be used to implement one or more of the systems disclosed herein.

Computing device 10 may include a graphics processor 24. In some embodiments, the graphics processor 24 is integrated into the processing unit 20, such that the graphics processor 24 may share Random Access Memory (RAM) with the processing unit 20. Alternatively, or in addition, the computing device 10 may include a discrete graphics processor 24 that is separate from the processing unit 20. In some such cases, the graphics processor 24 may have separate RAM from the processing unit 20. Computing device 10 might be a video game console device, a general-purpose laptop or desktop computer, a smart phone, a tablet, a server, or other suitable system.

Computing device 10 also includes various components for enabling input/output, such as an I/O 32, a user I/O 34, a display I/O 36, and a network I/O 38. I/O 32 interacts with storage element 40 and, through a device 42, removable storage media 44 in order to provide storage for computing device 10. Processing unit 20 can communicate through I/O 32 to store data. In addition to storage 40 and removable storage media 44, computing device 10 is also shown including ROM (Read-Only Memory) 46 and RAM 48. RAM 48 may be used for data that is accessed frequently during execution of software.

User I/O 34 is used to send and receive commands between processing unit 20 and user devices, such as keyboards or game controllers. In some embodiments, the user I/O can include a touchscreen. The touchscreen can be a capacitive touchscreen, a resistive touchscreen, or other type of touchscreen technology that is configured to receive user input through tactile inputs from the user. Display I/O 36 provides input/output functions that are used to display images. Network I/O 38 is used for input/output functions for a network. Network I/O 38 may be used during execution, such as when a client is connecting to a server over a network.

Display output signals produced by display I/O 36 comprising signals for displaying visual content produced by computing device 10 on a display device, such as graphics, GUIs, video, and/or other visual content. Computing device 10 may comprise one or more integrated displays configured to receive display output signals produced by display I/O 36. According to some embodiments, display output signals produced by display I/O 36 may also be output to one or more display devices external to computing device 10, such as display 16.

The computing device 10 can also include other features, such as a clock 50, flash memory 52, and other components. An audio/video player 56 might also be used to play a video sequence, such as a movie. It should be understood that other components may be provided in computing device 10 and that a person skilled in the art will appreciate other variations of computing device 10.

Program code can be stored in ROM 46, RAM 48, or storage 40 (which might comprise hard disk, other magnetic storage, optical storage, other non-volatile storage or a combination or variation of these). Part of the program code can be stored in ROM that is programmable (ROM, PROM, EPROM, EEPROM, and so forth), part of the program code can be stored in storage 40, and/or on removable media such as media 12 (which can be a CD-ROM, cartridge, memory chip or the like, or obtained over a network or other electronic channel as needed). In general, program code can be found embodied in a tangible non-transitory signal-bearing medium.

Random access memory (RAM) 48 (and possibly other storage) is usable to store variables and other processor data as needed. RAM is used and holds data that is generated during the execution of an application and portions thereof might also be reserved for frame buffers, application state information, and/or other data needed or usable for interpreting user input and generating display outputs. Generally, RAM 48 is volatile storage and data stored within RAM 48 may be lost when the computing device 10 is turned off or loses power.

As computing device 10 reads media 12 and provides an application, information may be read from media 12 and stored in a memory device, such as RAM 48. Additionally, data from storage 40, ROM 46, servers accessed via a network (not shown), or removable storage media 46 may be read and loaded into RAM 48. Although data is described as being found in RAM 48, it will be understood that data does not have to be stored in RAM 48 and may be stored in other memory accessible to processing unit 20 or distributed among several media, such as media 12 and storage 40.

Some portions of the detailed descriptions above are presented in terms of symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

The disclosed subject matter also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but not limited to, any type of disk including optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The disclosed subject matter may be provided as a computer program product, or software, which may include a machine-readable medium having stored thereon instructions, which may be used to program a computer system (or other electronic devices) to perform a process according to the disclosed subject matter. A machine-readable medium includes any mechanism for storing or transmitting information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices, etc.).

It should be understood that the original applicant herein determines which technologies to use and/or productize based on their usefulness and relevance in a constantly evolving field, and what is best for it and its players and users. Accordingly, it may be the case that the systems and methods described herein have not yet been and/or will not later be used and/or productized by the original applicant. It should also be understood that implementation and use, if any, by the original applicant, of the systems and methods described herein are performed in accordance with its privacy policies. These policies are intended to respect and prioritize player privacy, and to meet or exceed government and legal requirements of respective jurisdictions. To the extent that such an implementation or use of these systems and methods enables or requires processing of user personal information, such processing is performed (i) as outlined in the privacy policies; (ii) pursuant to a valid legal mechanism, including but not limited to providing adequate notice or where required, obtaining the consent of the respective user; and (iii) in accordance with the player or user's privacy settings or preferences. It should also be understood that the original applicant intends that the systems and methods described herein, if implemented or used by other entities, be in compliance with privacy policies and practices that are consistent with its objective to respect players and user privacy.

Certain example embodiments are described above to provide an overall understanding of the principles of the structure, function, manufacture and use of the devices, systems, and methods described herein. One or more examples of these embodiments are illustrated in the accompanying drawings. Those skilled in the art will understand that the descriptions herein and the accompanying drawings are intended to be illustrative, and not restrictive. Many other implementations will be apparent to those of skill in the art based upon the above description. Such modifications and variations are intended to be included within the scope of the present disclosure. The scope of the present disclosure should, therefore, be considered with reference to the claims, along with the full scope of equivalents to which such claims are entitled. The features illustrated or described in connection with one exemplary embodiment may be combined with the features of other embodiments. In some instances, well-known structures and devices are shown in block diagram form, rather than in detail, in order to avoid obscuring the disclosed subject matter.

What is claimed is:

1. A system comprising:
at least one processor; and
at least one memory device, wherein the at least one memory device is communicatively coupled to the at least one processor, the at least one memory device storing computer-executable instructions defining at least an animation solver, wherein execution of the computer-executable instructions, during runtime of the animation solver, causes the at least one processor to:
receive a joint selection corresponding to a first joint among a plurality of joints;
instantiate a locator object in a first world space position;
translate the first world space position of the locator object to a local position corresponding to the first joint;
cause the first joint to be manipulated to the local position based in part on joint logic corresponding to the joint selection; and
produce one or more keyframes based at least in part on the manipulation.

2. The system of claim 1, wherein causing the first joint to be manipulated to the local position causes one or more joints coupled to the first joint to be manipulated in response to the manipulation of the first joint.

3. The system of claim 2, wherein joints coupled to the first joint are each manipulated based in part on the joint logic corresponding to each coupled joint.

4. The system of claim 3, wherein the joint logic is configurable.

5. The system of claim 4, wherein the joint logic enables the animation solver to manipulate joints without use of rig objects.

6. The system of claim 5, wherein the one or more keyframes produced include a timestamp corresponding to one or more animation sequences.

7. The system of claim 6, wherein the one or more keyframes produced are used to produce a keyframe animation through keyframe interpolation.

8. A computer implemented method for an animation solver comprising:
receiving a joint selection corresponding to a first joint among a plurality of joints;
instantiating a locator object in a first world space position;
translating the first world space position of the locator object to a local position corresponding to the first joint;
causing the first joint to be manipulated to the local position based in part on joint logic corresponding to the joint selection; and
producing one or more keyframes based at least in part on the manipulation.

9. The computer implemented method of claim 8, causing the first joint to be manipulated to the local position causes one or more joints coupled to the first joint to be manipulated in response to the manipulation of the first joint.

10. The computer implemented method of claim 9, wherein joints coupled to the first joint are each manipulated based in part on the joint logic corresponding to each coupled joint.

11. The computer implemented method of claim 10, wherein the joint logic is configurable.

12. The computer implemented method of claim 11, wherein the joint logic enables the animation solver to manipulate joints without use of rig objects.

13. The computer implemented method of claim 12, wherein the one or more keyframes produced include a timestamp corresponding to one or more animation sequences.

14. The computer implemented method of claim 13, wherein the one or more keyframes produced are used to produce a keyframe animation through keyframe interpolation.

15. A computer readable medium storing computer-executable instructions defining at least an animation solver, wherein execution of the computer-executable instructions configure at least one processor to execute a method comprising:
receiving a joint selection corresponding to a first joint among a plurality of joints;
instantiating a locator object in a first world space position;
translating the first world space position of the locator object to a local position corresponding to the first joint;
causing the first joint to be manipulated to the local position based in part on joint logic corresponding to the joint selection; and
producing one or more keyframes based at least in part on the manipulation.

16. The computer readable medium of claim 15, wherein causing the first joint to be manipulated to the local position causes one or more joints coupled to the first joint to be manipulated in response to the manipulation of the first joint.

17. The computer readable medium of claim 16, wherein joints coupled to the first joint are each manipulated based in part on the joint logic corresponding to each coupled joint.

18. The computer readable medium of claim 17, wherein the joint logic is configurable.

19. The computer readable medium of claim 18, wherein the joint logic enables the animation solver to manipulate joints without use of rig objects.

20. The computer readable medium of claim 19, wherein the one or more keyframes produced include a timestamp corresponding to one or more animation sequences.
